(19) United States
(12) Patent Application Publication
(10) Pub. No.: US 2011/0055875 A1
(43) Pub. Date: Mar. 3, 2011

(54) METHOD AND APPARATUS FOR PROVIDING WIMAX OVER CATV, DBS, PON INFRASTRUCTURE

(75) Inventor: Mordechai Zussman, Kiryat Arie Petah Tikva (IL)

(73) Assignee: CLARITON NETWORKS, LTD., Kiryat Arie Petah Tikva (IL)

(21) Appl. No.: 12/665,630

(22) PCT Filed: Jun. 23, 2008
(86) PCT No.: PCT/US08/67915

§ 371 Date: Nov. 17, 2010

Related U.S. Application Data
(60) Provisional application No. 60/945,699, filed on Jun. 22, 2007.

(51) Int. Cl. H04N 7/20; H04W 4/00; H04N 7/173; H04B 10/02

(52) U.S. Cl. 725/65; 370/328; 725/127; 725/111; 398/116

(57) ABSTRACT

A method and apparatus for providing WiMAX coverage via a wired network are provided. For example, systems and methods are discussed in which a Cable TV (“CATV”) network, Direct Broadcasting Satellite (“DBS”) and/or Passive Optical Network (PON) are used in order to deliver the native WiMAX signals into the buildings or an area in which WiMAX coverage is desired, where a small Consumer Premise Device is used to transmit and receive the signals to and from the WiMAX devices.

### CROSS-REFERENCE TO RELATED PATENT APPLICATIONS

This application claims the benefit of Provisional Patent Application No. 60/945,699, filed on Jun. 22, 2007, the disclosure of which is incorporated herein in its entirety by reference.

Each of U.S. patent application Ser. Nos. 10/497,588 and 10/476,412, and Provisional Patent Application No. 60/826,679, assigned to a common assignee with the current application, provide useful background information that may assist the interested reader in more fully understanding the subject matter below and as such are hereby incorporated herein in their entirety by this reference thereto.

### BACKGROUND OF THE INVENTION

1. Field of the Invention

The present invention relates to a new system and topology for providing WiMAX coverage by using a wired network, such as a Cable TV (“CATV”) network, Direct Broadcasting Satellite (“DBS”) and/or Passive Optical Network (PON) in order to deliver the native WiMAX signals. The system can improve the in-building coverage and the total available capacity of WiMAX systems, using these networks. The system is designed to support residential buildings as well as commercial building like hotels, campuses, hospital, high rise buildings, and the like.

The system is designed to support all WiMAX frequencies allocations.

2. Description of the Related Art

One of the major challenges of wireless networks, such as WiMAX networks, is in-building coverage. WiMAX antennas are typically located outside buildings, while in many cases the users are located inside the buildings. As a result, the WiMAX signals have to penetrate the walls of the buildings. While penetrating the walls, the signal is attenuated, causing degradation of the communication quality.

This challenge of in-building coverage for cellular networks is a well known challenge and there are some methods to address this challenge, mainly repeaters and in-building Distributed Antenna Systems (DAS). Both methods are typically used for highly populated locations, such as office buildings, public buildings, shopping centers and campuses.

### SUMMARY OF THE INVENTION

It is therefore an object of to overcome the above identified limitations of the present wireless systems by providing methods and systems in which a wired network, such as a Cable TV (“CATV”) network, Direct Broadcasting Satellite (“DBS”) and/or Passive Optical Network (PON) are used in order to deliver the native WiMAX signals into the buildings, where a small Customer Premise Equipment (CPE) is used to transmit and receive the signals to and from the WiMAX devices. Thus, exemplary embodiments of the invention can address the challenge of in-building coverage for residential and commercial locations such as private houses, apartment buildings, hotels, office buildings, business center and SOHO. The described invention can support multiple types of WiMAX and Wibro technologies for the frequency range of 2 to 11 Ghz. However, even though the main application of such a system is in-building coverage, the system may be used for outdoor coverage as well, at locations where CATV is deployed and the existing WiMAX coverage is insufficient.

According to an aspect of the present invention, there is provided a system and method of providing WiMAX coverage over a Cable Television (CATV) infrastructure.

According to another aspect of the present invention, there is provided a system and method of providing WiMAX coverage over a Passive Optical Network (PON) infrastructure.

According to another aspect of the present invention, there is provided a system and method of providing WiMAX coverage over a Direct Broadcasting Satellite (DBS) infrastructure.

### BRIEF DESCRIPTION OF THE DRAWINGS

The above and other features and advantages of the present invention will become more apparent by describing in detail exemplary embodiments thereof with reference to the attached drawings in which:

FIG. 1 is an illustration of the architecture of a traditional CATV network.

FIG. 2 is a diagram of a CATV frequency spectrum according to an embodiment of the present invention.

FIG. 3 is an exemplary CATV network architecture according to an embodiment of the present invention.

FIG. 4 is a diagram showing a system for use in combination with that of FIG. 3 for carrying Multiple Input Multiple Output (MIMO) WiMAX signals over CATV according to an embodiment of the present invention.

FIG. 5 is a diagram of a typical passive optical network (PON).

FIG. 6 is diagram of an exemplary system for providing WiMAX coverage through a passive optical network (PON) according to an embodiment of the present invention.

FIG. 7 is a diagram of a PON frequency spectrum according to an embodiment of the present invention in which WiMAX signals are carried on the same wavelength as CATV signals.

FIG. 8 is diagram of an exemplary system for providing WiMAX coverage through a Direct Broadcast Satellite (DBS) network according to an embodiment of the present invention.

FIG. 9 is a diagram of a DBS frequency spectrum according to an embodiment of the present invention.

### DETAILED DESCRIPTION OF THE EXEMPLARY EMBODIMENTS

The present invention will now be described more fully with reference to the accompanying drawings, in which exemplary embodiments of the invention are shown.

First Aspect of the Present Invention:

In a first aspect of the invention, there is provided a system for providing WiMAX coverage over a Cable Television (CATV) infrastructure.

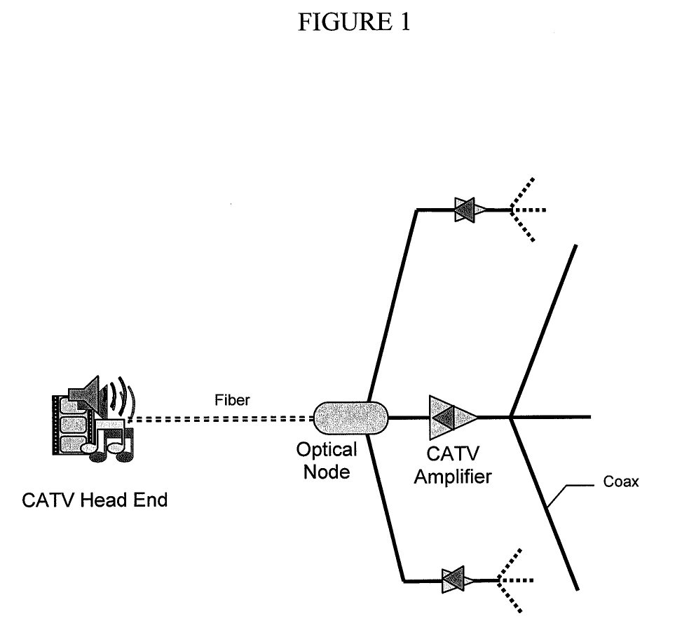

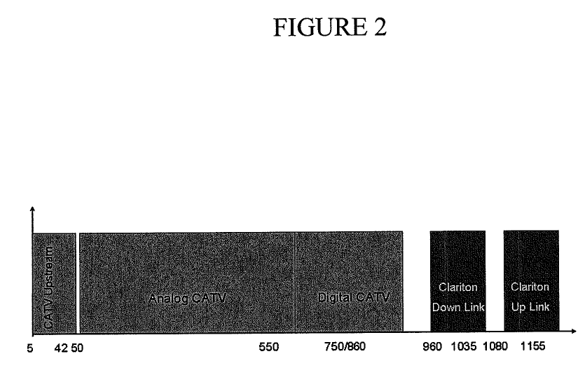

FIG. 1 illustrates the architecture of a traditional CATV network. A traditional CATV network is a two way network having a tree topology and including fiber optic link, cables, amplifiers, signal splitters/combiners and filters. The CATV networks are designed to support CATV signals both at the Upstream and at the Downstream Link. The Upstream spectrum is usually from 5 to 42 Mhz in the United States and from 5 to 65 Mhz in the European Union. The Downstream spectrum is usually from 50 to 860 Mhz in the United States and from 70 to 860 Mhz in the European Union. The typical CATV frequency spectrum in the United States is illustrated in FIG. 2 from 5 to 860 Mhz.

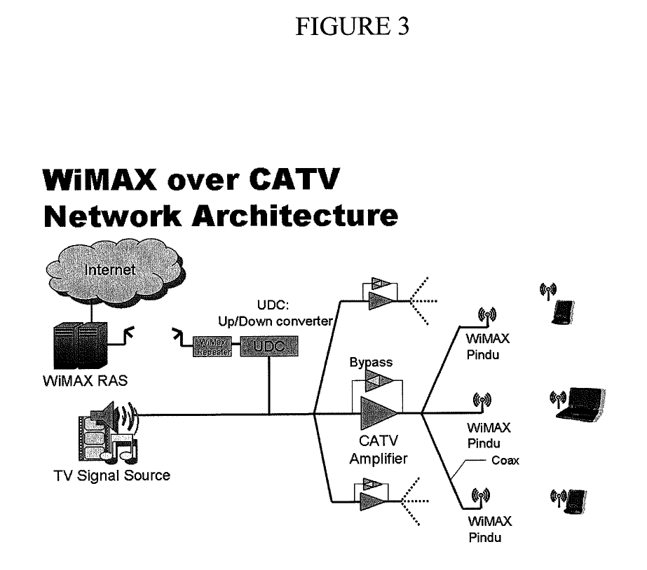

An exemplary embodiment of a first aspect of the invention will now be described with reference to FIGS. 2 and 3. In particular, a system in which a CATV infrastructure is used to provide WiMAX coverage is described. Even though the main application of such a system is in-building coverage, the system may be used for outdoor coverage as well, at locations where CATV is deployed and the existing WiMAX coverage is insufficient. The same architecture may be used without the optical fiber elements shown in the architecture of FIG. 1 in a stand-alone building or campus using existing TV coax.

According to the exemplary system shown in FIG. 3, the WiMAX signals transmitted over the air are received via WiMAX repeater or WiMAX Base Station. The WiMAX signals from the repeater are down and up converted by the Up/Down Converter (UDC) into the 960 to 1155 Mhz spectrum as shown in FIG. 2. In particular, down stream signals are converted to 960-1035 Mhz and upstream signals are converted to 1080-1155 Mhz. The modified WiMAX signals are forwarded via the CATV infrastructure to each one of the network's subscribers. At the network subscriber side, a CPE unit is installed which converts the 960-1155 Mhz modified WiMAX signals back to the original WiMAX signals.

As shown in FIG. 3, in order to be able to transmit the modified WiMAX signals via the CATV infrastructure, bypass units are installed over each CATV amplifier. The base station RF signals are converted to optical signals using an RF/Optic converter. The invention is designed and enables to support all generation of WiMAX systems including MIMO WiMAX systems.

Down Link signals are distributed from the WiMAX Base Station/Repeater through the bypass and the CATV infrastructure to all the network subscribers' simultaneously.

Up Link signals received from each network subscriber are combined at the CATV infrastructure and transmitted through the bypass to the WiMAX base station/Repeater.

Since different technologies (e.g. WiMAX, WiBro) and different WiMAX operators are using different frequencies, signals of different WiMAX networks can be combined together and propagated over the same CATV infrastructure without any overlaps between the networks.

WiMAX can be implemented using Time Division Duplex (TDD) or Frequency Division Duplex (FDD). The exemplary embodiments of the present invention can be designed for implementations of both methods (TDD and FDD).

In an exemplary TDD configuration, WiMAX down link signals and uplink signals are differentiated by timing and the transmission is half duplex. WiMAX TDD signals are converted at the headend into FDD signals and transmitted over the CATV infrastructure with the FDD signals allocated to 960-1035 Mhz at down link spectrum and 1080-1155 at up link spectrum. The FDD signals are converted back to TDD WiMAX signals at the subscriber network unit. Timing synchronization signal between the WiMAX Base Station or WiMAX repeater is used to synchronize both the Up Down (UDC) converter at the headend and the units at the customer premises (CPE).

In an exemplary FDD configuration, the WiMAX system is transmitting full duplex where down link and up link signals are separated by frequency. In the FDD mode, the WiMAX FDD signals are converted at the headend to the 960-1155 Mhz FDD signals over the CATV infrastructure and transmitted via the subscriber network unit as WiMAX FDD signals.

Embodiments of the present invention support both single WiMAX system solution as well as MIMO WiMAX solution.

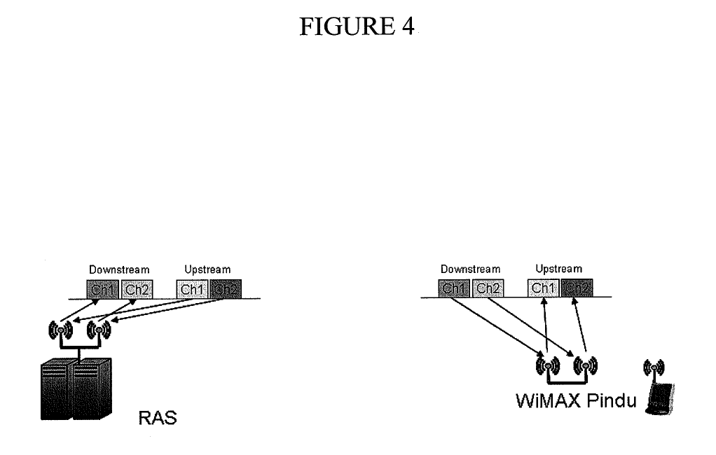

MIMO WiMAX systems are implemented using multiple antennas. In embodiments of the present invention directed to a MIMO system such as that shown in FIG. 4, the system is designed to support multiple antennas by allocation of multiple channels in the CATV band, where each channel is associated with a different antenna.

In the above description, exemplary embodiments have been described to allow the use of a CATV infrastructure to provide WiMAX coverage in areas where WiMAX coverage is desired.

Second Aspect of the Present Invention:

In a second aspect of the invention, there is provided a system for providing WiMAX coverage over a Passive Optical Network (PON) infrastructure.

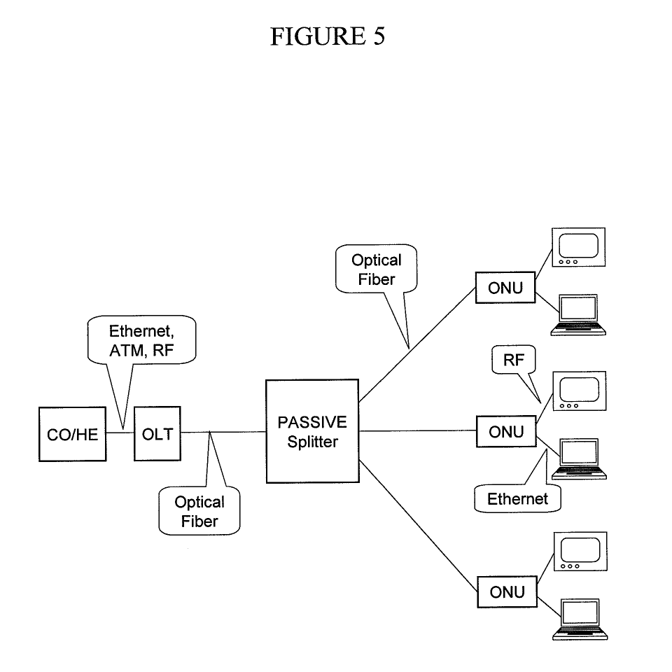

A PON is an access network based on optical fibers. FIG. 5 illustrates the architecture of a typical passive optical network. The network is built as a Point to Multi-point network, where a single optical interface, known as Optical Line Terminal (OLT), is located at the Central Office (CO) or Head-End (HE) and serves multiple users (typically 16, 64 up to 128 users). The OLT is connected via optical fiber (usually called feeder) to a passive splitter, which splits the optical signal among multiple optical fibers (usually called distribution lines or drops). The passive splitter may be located at the CO (centralized split) or at a passive cabinet in the field (distributed split). The distribution lines (or drops) terminate with an Optical Network Unit (ONU) which converts the optical signals to electrical signals. The ONU may be located at the subscriber's home (AKA FTTH—Fiber To The Home), at the subscriber's building (AKA FTTB) where the electrical signals are forwarded to the end users using the building's infrastructure (e.g. CAT 5) or at the curb (AKA FTTC) where the electrical signals are forwarded to the end users using copper wires (e.g. DSL). There are several flavors of PON, such as APON, BPON, EPON, GPON and GePON. All flavors share the same basic architecture of passive splitting and differ from each other by the data rate and the protocols.

Two types of transmissions are used over PON: Digital Transmissions and RF Transmissions. Digital transmissions are typically used for internet access where the IP packets are carried over either ATM (e.g. APON, BPON and GPON) or Ethernet (e.g. EPON, GPON, GePON). Digital transmissions are typically bi-directional transmissions, where each direction is carried over a different wavelength. Typical wavelengths are 1310 nm for Upstream and 1490 nm (APON, BPON and GPON) or 1550 nm (EPON and GePON) for downstream. Another option, although less common, is to use a different fiber for each direction.

RF Transmissions are usually used for CATV transmissions at the downstream direction. The CATV RF signals are converted to optical signals, typically at wavelength of 1550 nm, and are forwarded along the PON to the ONU, which converts the optical signals back to RF signals. The RF output of the ONU is connected to the RF input of the CATV set-top box, allowing transmission of CATV signals over PON while using the existing CATV headend equipment and set-top boxes.

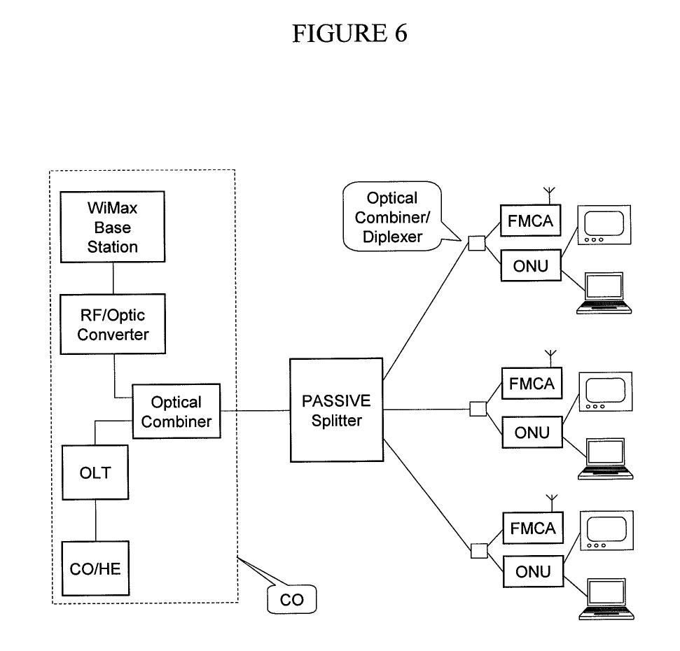

An exemplary embodiment of the second aspect of the present invention will now be described with reference to FIG. 6. In particular, a system in which the PON infrastructure is used to provide WiMAX coverage is described. Even though the main application of such a system is in-building coverage, the system may be used for outdoor coverage as well, at locations where PON is deployed and the existing WiMAX coverage is insufficient.

According to an exemplary embodiment of the present invention, the native WiMAX signals are forwarded over the PON between the CO and each one of the network's subscribers. A WiMAX base station is installed at the CO, preferably co-located with the OLT. The base station RF signals are converted to optical signals using an RF/Optic converter. The optical signals are combined with the OLT optical signals and propagated along the PON to the ONU. A small CPE, called FMCA (Fiber Mounted Cellular Antenna) equipped with an optical interface and a WiMAX antenna is installed at the subscriber home, preferably co-located or even integrated with the ONU. The FMCA separates the optical signals originated from the RF signals of the WiMAX base station and converts them back to RF signals. These RF signals are transmitted by the FMCA using a WiMAX antenna, providing a WiMAX coverage at the proximity of the FMCA.

At the upstream direction, the WiMAX signals are received by the FMCA and converted to optical signals. These signals are combined with the optical signals generated by the ONU and forwarded to the CO over the PON. Note that at the upstream direction the PON passive splitter acts as a combiner, combining optical signals generated by several FMCAs. The combined optical signal is received at the CO, where the optical signal originated from the FMCAs is converted back to RF signals. These signals are forwarded to the RF input of the WiMAX base station. In this way the base station receives all the signals that are received by the antennas of each one of the FMCAs.

The following sections describe several methods for combining the WiMAX signals with other signals of the PON. Note that each one of the methods can be implemented either at the upstream direction or the downstream direction and each direction can be implemented using a different method.

A first method for combining the WiMAX signals with other signals of the PON involves carrying the WiMAX signals on dedicated wavelengths not used by the PON wherein the frequency of the RF signals remains that which is used over the air.

As described above, PON signals are carried over several wavelengths. Typically, wavelength of 1490 nm and 1550 nm are used for downstream traffic and wavelength of 1310 nm is used for upstream traffic. According to the first method, the WiMAX signals are carried over additional wavelength which is not used by the PON. For example, this wavelength can be 1490 nm in PONs which do not use this wavelength (i.e. EPON) or some other wavelength. In preferred embodiments, the wavelength at which the WiMAX signals are carried is in the range supported by the PON passive splitter.

The RF signals are converted to optical signals at the dedicated wavelength as is, at the same frequencies that are used over the air, without any frequency conversions or any other processing. Since different technologies (e.g. WiMAX, WiBro) and different WiMAX operators are using different frequencies, signals of different WiMAX networks can be combined together and propagated over the same PON without any overlaps between the networks.

A second method for combining the WiMAX signals with the other signals of the PON involves carrying the RF signals over a dedicated wavelength wherein the frequency of the RF signals is shifted (or converted) to a lower frequency. Conversion of complete WiMAX band, from RF to optic and vice versa, requires expensive wideband RF/Optic converters. Since a WiMAX operator uses only small portion of the band (e.g. 3.5 MHz up to 20 MHz bandwidth within the WiMAX band), in preferred embodiments of the present invention, only this portion of the band is shifted to a lower frequency, converted to optical signals, converted back to RF frequency at the other end of the network and shifted back the original frequency. In this way, narrower band and cheaper components can be used. This method can also support multiple WiMAX networks by shifting the actual band of each network to a different frequency band at one end of the PON and shift it back to the original air frequency at the other end of the PON.

A third method for combining the WiMAX signals with the other signals of the PON involves carrying the RF signals over a wavelength shared with the PON application wherein the frequency of the WiMAX signals is shifted (or converted) to a frequency not used by the PON application.

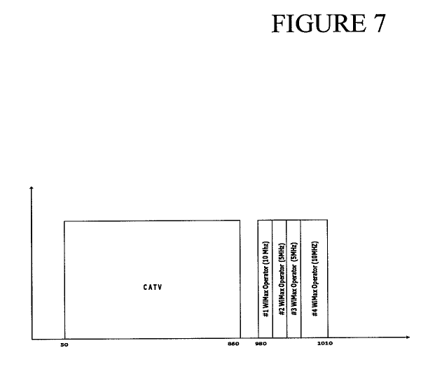

As mentioned above, converting a wideband RF signal to optic signal and vice versa requires expensive wideband RF/Optic converters. The down link frequency range used by the CATV application starts at 50 MHz and ends at 860 MHz. Combining this signal with a WiMAX down link signal will result with total bandwidth of more than 2 GHz. In order to reduce the bandwidth (and the cost) of the RF/Optic converters, the WiMAX down link signals can be shifted from the air frequency to a frequency which is not used by the PON application. The frequency shift takes place on a portion of the band which is actually used by the WiMAX operator (e.g. 3.5 MHz up to 20 MHz bandwidth within the WiMAX band). In the case of multiple WiMAX networks, the signals of each network can be shifted to a different, unused frequency range. FIG. 7 is a diagram which describes a PON spectrum of a downlink wavelength which is shared by a CATV application and four WiMAX networks. The total bandwidth used by these networks is 30 MHz down link and 30 MHz up link.

In the above description, exemplary embodiments have been described to allow the use of a PON infrastructure to provide WiMAX coverage in areas where WiMAX coverage is desired.

Third Aspect of the Present Invention

In a third aspect of the present invention, there is provided a system for providing WiMAX coverage over a Direct Broadcast Satellite (DBS) infrastructure.

A traditional DBS network is a one way network having an antenna and RF converter at the roof. The satellite signals received at the DBS antenna are converted to 950-1450 MHz and routed to the customer premises via coaxial cable, amplifiers, splitters/combiners and filters. The DBS networks are designed to support downstream signals only.

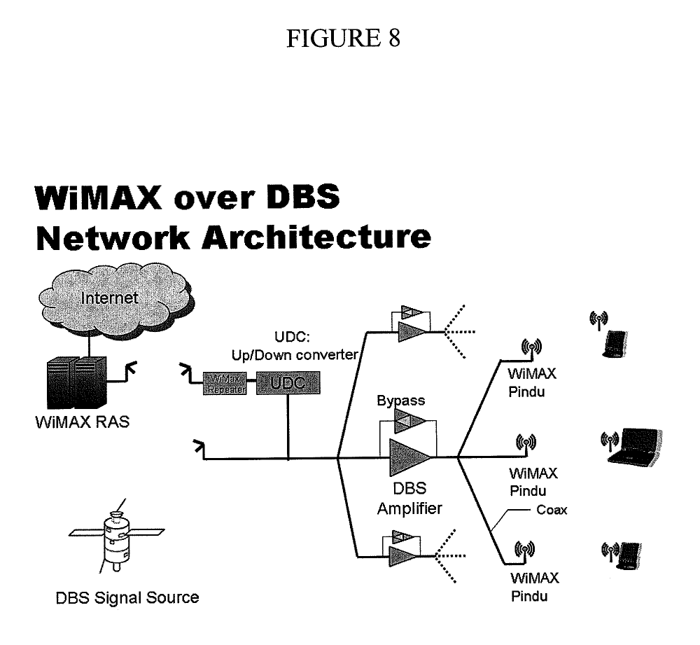

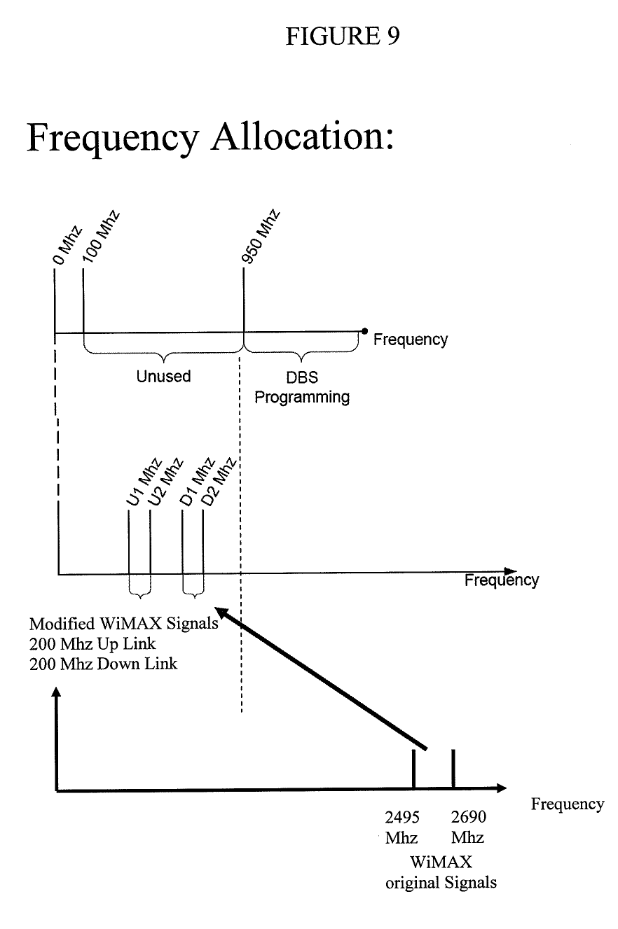

An exemplary embodiment of the third aspect of the present invention will now be described with reference to FIGS. 8 and 9. In particular, a system in which the DBS infrastructure is used to provide WiMAX coverage is described.

Even though the main application of such a system is in-building coverage, the system may be used for outdoor coverage as well, at locations where DBS is deployed and the existing WiMAX coverage is insufficient.

According to an exemplary embodiments of the present invention shown in FIG. 8, the WiMAX signals transmitted over the air are received via WiMAX repeater or through WiMAX Base Station. As shown in FIG. 9, the WiMAX signals from the repeater are down and up converted into the any available 200 MHz at the 50 to 750 MHz spectrum for Down stream signals, and any available 200 Mhz at the 50 to 750 Mhz spectrum for upstream signals. The modified WiMAX signals are forwarded via the coaxial infrastructure of the DBS network to each one of the network's subscribers. This is done in a similar manner as described above for the first aspect of the present invention and as such will not be described here. At the network subscriber side, a CPE unit is installed which converts the modified WiMAX signals back to the original WiMAX signals.

Thus, there can be provided a system and method to allow the use of a DBS infrastructure to provide WiMAX coverage in areas where WiMAX coverage is desired.

While the present invention has been particularly described above with respect to the carrying WiMAX signals over particular types of wired networks, the present invention would be understood by those of ordinary skill in the art to extend to various other types of wired networks. Further, while the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method for providing WiMAX communication through a wired network, comprising:
communicating WiMAX signals and signals of the wired network, over the wired network, between an access point of the wired network and a termination point of the wired network;
providing, at the termination point of the wired network, a customer premise equipment that converts WiMAX signals received through the wired network to native WiMAX signals and that converts WiMAX signals to be transmitted from the termination point to the access point into signals to be sent via the wired network.

2. The method according to claim 1, wherein the termination point of the wired network is an indoor termination point of the wired network.

3. A method for providing WiMAX communication through a Cable TV (CATV) network, comprising:
providing a bypass device at an active point in a CATV network; and
communicating frequency shifted WiMAX signals and CATV signals, over the CATV network, between an access point of the CATV network and a termination point of the CATV network, wherein the CATV signals are communicated via the active point and the frequency shifted WiMAX signals are communicated via the bypass device.

4. The method according to claim 3, wherein the termination point of the CATV network is an indoor termination point of the CATV network.

5. The method according to claim 3, further comprising, at the termination point of the CATV network:
receiving shifted downlink WiMAX signals from the CATV network;
converting the shifted downlink WiMAX signals to original frequency downlink WiMAX signals;
outputting the original frequency downlink WiMAX signals to an antenna;
receiving original frequency uplink WiMAX signals from the antenna;
converting the original frequency uplink WiMAX signals to frequency shifted uplink WiMAX signals; and
outputting the shifted uplink WiMAX signals to the CATV network.

6. The method according to claim 5, further comprising, at the termination point of the CATV network, communicating CATV signals between the CATV network and at least one CATV device by coaxial cable.

7. The method according to claim 6, wherein the at least one CATV device is one or more of a TV, a set top box, and a cable modem.

8. The method according to claim 5, wherein the shifted uplink WiMAX signals have a frequency above 905 MHz.

9. The method according to claim 5, wherein the shifted downlink WiMAX signals have a frequency above 905 MHz.

10. The method according to claim 5, wherein the original frequency WiMAX signals are shifted to a band higher in frequency than the CATV signals.

11. The method according to claim 3, further comprising, at the access point of the CATV network:
receiving shifted uplink WiMAX signals from the CATV network;
converting the shifted uplink WiMAX signals to original frequency uplink WiMAX signals;
outputting the original frequency uplink WiMAX signals to a WiMAX base transceiver station/repeater (BTS);
receiving original frequency downlink WiMAX signals from the BTS;
converting the original frequency downlink WiMAX signals to shifted downlink WiMAX signals; and
outputting the shifted downlink WiMAX signals to the CATV network.

12. The method as set forth in claim 11, wherein the bypass device:
receives, as a coupled signal, the CATV signals and the frequency shifted WiMAX signals;
differentiates between the CATV signals of the coupled signal and the frequency shifted WiMAX signals of the coupled signal;
passes the CATV signals of the coupled signal through the active component of the CATV network;
passes only the frequency shifted WiMAX signals of the coupled signals around the active point of the CATV network; and
after passing the CATV signals and the frequency shifted WiMAX signals of the coupled signal, recombining the CATV signals with the frequency shifted WiMAX signals to provide a signal for further communication over the CATV network.

13. A system for communicating WiMAX signals over a cable television (CATV) network, comprising:
an access device at an access point of the CATV network, receiving original downlink signals, including downlink signals from one or more WiMAX networks from one or more WiMAX Base Station/Repeaters (BTS), and shifting the original downlink signals to a frequency band higher than CATV signals of the CATV network to provide shifted WiMAX signals, the access device having a frequency converter for providing frequency conversion in accordance with a predetermined frequency plan into predetermined sub-bands of said frequency band,
a Customer Premise Equipment (CPE) at a termination point of the CATV network, adapted to receive original uplink signals, and shifting the original uplink signals to a frequency band higher than CATV signals of the CATV network to provide shifted WiMAX signals; and
a bypass device at an active component of the CATV network, the shifted WiMAX signals being communicated over the CATV network between the access device and CPE via the bypass device.

14. The system according to claim 13, wherein the frequency band higher than the CATV signals of the CATV network is a band of 945-1120 MHz.

15. The system according to claim 13, wherein the frequency band higher than the CATV signals of the CATV network is a band of 960-1155 MHz.

16. The system as set forth in claim 15, wherein the access device:
receives downlink CATV signals from the CATV network;
shifts of the original downlink WiMAX signals to provide the shifted downlink WiMAX signals;
couples the downlink CATV signals and the shifted downlink WiMAX signals to provide a coupled downlink signal;
transports the coupled downlink signal through the CATV network;
receives a coupled uplink signal from the CATV network;
decouples the coupled uplink signal to provide uplink CATV signals and shifted uplink WiMAX signals;
shifts the shifted uplink WiMAX signals to provide restored uplink WiMAX signals corresponding in frequency to the original uplink WiMAX signals;
transports the uplink CATV signals to the CATV network; and
transports the restored uplink WiMAX signals to the one or more WiMAX network through the one or more WiMAX Base Station/Repeaters.

17. The system as set forth in claim 16, wherein the CPE:
receives uplink CATV signals;
receives original uplink WiMAX signals over a bi-directional antenna;
shifts the original uplink WiMAX signals to provide the shifted uplink WiMAX signals;
couples the uplink CATV signals and the shifted uplink WiMAX signals to provide a coupled uplink signal;
transports the coupled uplink signal through the CATV network;
receives the coupled downlink signal from the CATV network;
decouples the coupled downlink signal to provide downlink CATV signals and the shifted downlink WiMAX signals;
shifts the shifted downlink WiMAX signals to provide restored downlink signals corresponding in frequency to the original downlink WiMAX signals;
transports the downlink CATV signals to a television signal receiver; and
transmits the restored downlink WiMAX signals over the bi-directional antenna.

18. The system as set forth in claim 17, wherein the bypass device:
receives, as a coupled signal, one of the coupled uplink signal and the coupled downlink signal;
differentiates between CATV signals of the coupled signal and shifted WiMAX signals of the coupled signal;
passes the CATV signals of the coupled signal through the active point of the CATV network;
passes the shifted WiMAX signals of the coupled signal around the active point of the CATV network; and
after passing the CATV signals and the shifted WiMAX signals of the coupled signal, recombines the CATV signals of the coupled signal with the shifted WiMAx signals of the coupled signal to provide a restored coupled signal for transmission over the CATV network.

19. The system of claim 13, wherein the CPE at the termination point of the CATV network is at an indoor termination point of the CATV network.

20. An apparatus for supporting WiMAX communication at a termination point of a CATV network, comprising:
one or more frequency converters for:
converting original frequency uplink WiMAX signals of a WiMAX system of one or more WiMAX systems, received from an antenna, to corresponding shifted uplink WiMAX signals, and
converting shifted downlink WiMAX signals, received from the CATV network, to original frequency downlink WiMAX signals of the WiMAX network; and
wherein the shifted WiMAX signals of each WiMAX system has a respective sub-band frequencies in accordance with a predetermined frequency plan.

21. A system for communicating WiMAX signals, comprising:
a passive optical network (PON) between a central office (CO) and network subscribers, the CO having an optical line terminal (OLT) and a WiMAX base station;
an RF/Optic converter converting WiMAX base station radio frequency (RF) signals to and from corresponding optical signals;
an optical combiner combining signals of the OLT and signals of the RF/Optic converter for communication over the PON with at least one optical network unit (ONU) at a location of one or more of the network subscribers, whereby signals of the OLT and converted WiMAX signals are carried together over the PON;
a fiber mounted wireless antenna unit (FMCA) having an optical interface and a WiMAX antenna, and communicating WiMAX signals of the WiMAX antenna with the ONU, including performing conversions between WiMAX signals and optical signals;
wherein the FMCA obtains the converted WiMAX signals from the PON and converts them back to provide reconverted RF signals for transmission by the FMCA using the WiMAX antenna, and obtains WiMAX signals from the WiMAX antenna and converts them to provide optical signals for communication over the PON to the WiMAX base station at the CO, thereby providing WiMAX coverage at the location of the one or more of the network subscribers.

22. The system for communicating WiMAX signals as set forth in claim 21, wherein the FMCA and the ONU are integrated together.

23. The system for communicating WiMAX signals as set forth in claim 21, wherein the WiMAX signals converted to optical signals are carried over the PON on dedicated frequencies.

24. The system for communicating wireless signals as set forth in claim 23, wherein the native frequency of the WiMAX signals is frequency-converted prior to conversion to optical signals.

25. The system for communicating WiMAX signals as set forth in claim 21, wherein the WiMAX signals are combined with other RF signals to be carried over the PON prior to the conversion to optical signals.

26. The system for communicating WiMAX signals as set forth in claim 25, wherein the native frequency of the WiMAX signals is frequency-converted prior to conversion to optical signals.

27. A central office (CO) configured to operate in the system as set forth in claim 21.

28. A fiber mounted wireless antenna unit (FMCA) configured to operate in the system as set forth in claim 21.

29. A method for providing WiMAX coverage for a WiMAX device to communicate with a WiMAX network of a WiMAX system, the method comprising:
receiving direct broadcast satellite (DBS) programming signals through a DBS antenna connected to a DBS cable system;
receiving WiMAX signals of the WiMAX system;
communicating both the DBS programming signals and the WiMAX signals over the DBS cable system;
communicating the WiMAX signals, via the DBS cable system, between the WiMAX device and the WiMAX network.

30. The method for providing WiMAX coverage as set forth in claim 29, further comprising shifting the original frequency of the WiMAX signals to an unused part of the spectrum of the DBS cable system when the WiMAX signals are communicated over the DBS cable system.

31. The method for providing WiMAX coverage as set forth in claim 29, wherein the WiMAX device communicates the WiMAX signals through an indoor antenna.

32. The method for providing WiMAX coverage as set forth in claim 29, wherein the DBS cable system includes a bypass device, at each active component, for bypassing the WiMAX signals around the active component.

33. The method for providing WiMAX coverage as set forth in claim 29, further comprising an access device communicating the WiMAX signals to and from the WiMAX network, and shifting the original frequency of the WiMAX signals received from the WiMAX network to an unused part of the spectrum of the DBS cable system.

34. The method for providing WiMAX coverage as set forth in claim 29, further comprising an Customer Premise Equipment (CPE) for shifting the original frequency of the WiMAX signals received from the WiMAX device to an unused part of the spectrum of the DBS cable system.

35. The method for providing WiMAX coverage as set forth in claim 29, wherein the CPE comprises:
an antenna for communicating the WiMAX signals received from at the original frequency; and the CPE:
performs frequency shifting to provide shifted WiMAX signals, and
communicates the shifted WiMAX signals between the CPE and the DBS cable system.

36. The method for providing WiMAX coverage as set forth in claim 35, wherein the CPE performs the frequency shifting for more than one WiMAX system.

37. The method for providing WiMAX coverage as set forth in claim 29, wherein:
DBS cable system is the DBS cable system of a building;
the WiMAX device is an indoor WiMAX device;
the WiMAX coverage is indoor WiMAX coverage.

38. A method of communicating WiMAX signals over a direct broadcast satellite (DBS) network, comprising:
providing a access device in communication with a WiMAX base transceiver station/repeater (BTS) of a WiMAX network;
providing a customer premise equipment (CPE) at a termination point of said DBS network; and
providing a bypass device at every active component of said DBS network;
receiving, at said access device, unmodified down-link WiMAX signals, and, at said CPE, unmodified up-link WiMAX signals; and
shifting the frequency of the unmodified WiMAX signals, at the access device and the CPE, for communication over the DBS network at frequencies below the DBS programming signals of the DBS network.

39. A method of communicating WiMAX signals over part of a direct broadcast satellite (DBS) network, comprising:
providing an access device in communication with a WiMAX base transceiver station/repeater (BTS) of a WiMAX network;
providing an customer premise equipment (CPE) at a termination point of the DBS network;
providing a bypass device at an active component of the DBS network so as to provide a signal path around the active component;
receiving original WiMAX signals, including:
at said access device, original down-link WiMAX signals, and
at said CPE, original up-link WiMAX signals;
shifting said original WiMAX signals to a frequency band lower than the DBS programming signals of said DBS network to provide shifted WiMAX signals, including:
at said access device, shifted down-link WiMAX signals, and
at said CPE, shifted up-link WiMAX signals; and
communicating said shifted WiMAX signals along a signal path, between said access device and said CPE, using an access section of the DBS, and via said bypass device.

40. The method of communicating mobile radio traffic according to claim 39, wherein said original WiMAX signals are received in a frequency and format meeting a WiMAX standard.

41. The method of communicating cellular traffic according to claim 40, wherein said frequency band lower than said DBS programming signals of said DBS network is a band of 100-950 Mhz.

42. A method for transmitting Time Division Duplex 9TDD) WiMAX signals over a wired network comprising:
converting the TDD WiMAX signals into Frequency Division Duplex (FDD) WiMAX signals for transmission over the wired network between a headend equipment and a Customer Premise Equipment (CPE);
converting the received FDD WiMAX signals back to TDD WiMAX signals
wherein a synchronization signal from a WiMAX base station is used to switch the signal from down link to up link.

43. A method to synchronize a WiMAX base station with both a headend equipment (UDC) and a Customer Premise Equipment (CPE) connected to a wired network, comprising
injecting, into a signal path between the UDC to the CPE, one or more modulated pilot signals; and
using, by the UDC and CPE, said pilot signal in performing synchronization with the WiMAX base station.
